(19) United States
(12) Patent Application Publication
(10) Pub. No.: US 2023/0312318 A1
(43) Pub. Date: Oct. 5, 2023

(54) TOOL TO SEAL A BOTTLE NECK BY A STOPPER

(71) Applicant: NOVEMBAL USA INC., Edison, NJ (US)

(72) Inventors: Stéphane GRAUX, Liergues (FR); Richard LAMOUREUX, Rawdon (CA)

(21) Appl. No.: 18/024,836

(22) PCT Filed: Aug. 30, 2021
(86) PCT No.: PCT/IB2021/057898

§ 371 Date: Mar. 6, 2023

Related U.S. Application Data
(60) Provisional application No. 63/085,165, filed on Sep. 30, 2020.

(51) Int. Cl. B67B 1/06

(52) U.S. Cl. CPC B67B 1/06

(57) ABSTRACT

The invention is a tool to seal a bottle neck by a stopper where the stopper includes a top protruding part relative to a top surface. The tool includes a body with an inner hollow housing that is complementary in shape relative to the stopper to engage the stopper therein. The housing includes a top wall and a peripheral wall, where the top wall has at least one contact surface with the top surface of the stopper. The top wall includes one or more recesses that are located a border area of the top wall.

### TECHNICAL FIELD

The present invention relates to the field of liquid packaging, wherein it is very common to seal the aperture of a container with a stopper as “caps”.

Such container is an individual object. The container is usually made of plastic, glass or metal material. The container can be a bottle filled with a fluid or a liquid, especially of a food or a cosmetic product.

Moreover such bottle comprises a neck at a top part. The neck comprises a peripheral wall and at a top end an aperture through which the bottle is filled and emptied.

The stopper can be made of metal or plastic material. The stopper is made of one or several piece(s). A plastic stopper is mainly obtained through a molding process. Other parts or elements of the stopper can be created into the plastic piece through a cutting or slitting step during the manufacturing process.

Such stopper globally has a tubular or cylindrical shaped body closed at its top edge by a roof wall. The stopper body comprises a closure shell bottomly attached to a tamper band (also called “tamper evident band”) through a weakness line. Such weakness line is made of bridges, distributed around the closure shell and the tamper band. So the bridges link the closure shell and the tamper band together. Moreover the bridges are made when molding the stopper or after molding through a cutting step.

As known, according to a screw type stopper, the closure shell comprises inner thread(s) arranged on the inner side walls. In order to engage the stopper to seal the container, the peripheral wall of the neck comprises outer complementary fixation features, such as outer thread(s). The combination of outer and inner thread(s) allows the stopper to be screwed on the container neck to seal said container and unscrewed for container opening.

According to another known embodiment, a snap type stopper comprises inner annular area and the bottle neck fixation feature comprises outer fixation ring, in order to slot in force the stopper on the bottle neck. Moreover a snap type stopper comprises a closure with a movable sealing roof from a closing position to a part opening, and reversely. The roof may be separating upon opening or may remain connected with the closure shell or the tamper band.

According to another combined possibility, the stopper can be of the screw type with a snap roof. During bottle opening, first the consumer unscrews the stopper and the weakness line is broken to separate the closure shell from the tamper band. Then when the inner thread(s) are disengaged from the outer thread(s) of the bottle neck finish, the consumer upwardly pushes with a finger, especially the thumb, against an edge of the roof diametrically located at the opposite of the hinge. So the roof is raised up and pivotates around the hinge. After opening, the roof remains attached thanks to the hinge to the tamper band, which is secured on the container neck.

Moreover the tamper band comprises an inner annular bead, located at a bottom part. Such inner bead cooperates with an outer annular ring outwardly managed on the peripheral wall of the bottle neck, under the outer thread(s).

When sealing the bottle by screwing the stopper on the bottle neck, the bead crosses the outer ring and gets engaged in order to lock the tamper band relative to the bottle neck. So, when opening by unscrewing the stopper, the tamper band remains on the bottle neck and only the closure shell is moved up. During unscrewing, the bridges of the weakness line are torn apart from the closure shell until they break and the closure shell can be moved relative to the tamper band secured on the bottle neck.

Thus sealing of a bottle neck by a screw type stopper is operated thanks to a tool, also called “capping chuck”.

The invention especially relates to a tool to seal a bottle neck by a screw type stopper.

Such tool comprises a body, made of one or several parts. The body globally has a cylindrical inner shape with a housing made of a blind hole into a bottom part of the body. The housing is complementary dimensioned relative to the dimensions of the stopper to be inserted therein.

Especially the body comprises several parts, such as jaws, which are laterally movable in order to allow the insertion and the further ejection of a stopper, when such stopper comprises top parts protruding relative to bottom parts. In others words, when the stopper comprises a top diameter greater than a bottom diameter, then the body comprises jaws moved into a opened position when inserting the stopper and into a locking position once the stopper is inserted and to secure the stopper into the housing.

Moreover the housing comprises an inner peripheral wall with vertical grooves so called “teeth”. The teeth are complementary shaped relative to stripes so called “knurls”. The knurls are vertically made on an outer peripheral wall of the stopper. The cooperation of the knurls with the teeth when the tool is engaged on the stopper, angularly secured the stopper into the housing. Thereby once engaged, the stopper cannot turn relative to the tool.

According to a specific known embodiment, the inner peripheral wall of the housing comprises secure features, so called “detents”. Several detents are regularly distributed around the inner peripheral wall. Especially when there are an even number of detents, two of the detents are both diametrically located relative to each others, in order to pinch the stopper once engaged. The detents are located around the inner peripheral wall at the area of the teeth. The detents are movable in an horizontal direction relative to the tool axis, along a hollow channel complementary made into the body. The detents can be repelled into a pinch position thanks to elastic features, such as springs, or thanks to elastomeric components, such as an o-ring such as shown on FIGS. 1 to 3 or a quad-ring such as shown in FIG. 4. The detents inner extremity comprises a spherical ball or a cylindrical element, to get into contact with the knurls of the stopper. So when the stopper is engaged into the tool, the detents are pushed back into their channels and the repelled forces of the detents secure the stopper by holding it into the housing. The function of the detents is also to orient the stopper upon insertion into the capping chuck, by aligning the stopper knurls with the teeth and then to maintain the stopper once inserted, in order to prevent from free falling off the housing of the capping chuck.

Usually the tool also comprises a pusher in order to eject the engaged stopper. The pusher is top and middle located into a hole made in the housing. The pusher is vertically slidable relative to the central hole. So once the stopper is sealed on the bottle neck, the pusher is downwardly moved to push on a top surface of the stopper, to eject it from the housing.

Thus when sealing a bottle neck, the stopper is engaged into the housing of the tool. The tool is positioned over the bottle neck and the tool is moved in rotation, so that the inner thread(s) of the stopper cooperate with the outer thread(s) of the bottle neck until the bead of the tamper band crosses the outer ring of the bottle neck to lock the stopper relative to the bottle neck.

### BACKGROUND ART

Due to the flat top surface of the stopper, the housing of the tool comprises a top wall which extends in a continuous horizontal way. The top wall is only discontinuous in a middle area where the pusher vertically slides. When the stopper is engaged into the housing, the continuous top wall remains in contact with the top surface of the stopper.

Known tool does not allow insertion of a stopper with a protruding part relative to the top surface, such as a tongue outwardly shaped to allow the consumer to open the closure shell. However the housing must keep the contact of the top wall on the top surface of the stopper, in order to allow the stopper to be perfectly engaged into the housing, so that the top surface is horizontally oriented, to allow the top load to be transferred from the capping head to the bottle.

### SUMMARY OF INVENTION

An object of the present invention is to improve a tool to seal a bottle neck by a stopper, the stopper comprising a top protruding part relative to a top surface. Such tool comprises a body with an inner housing complementary dimensioned relative to the stopper to engage the stopper therein. Moreover the tool comprises an inner peripheral wall with teeth to angularly secure the stopper into the housing. The tool also comprises a top wall which allow the stopper with the top protruding part to be perfectly inserted and secured into the housing.

Therefore the tool according to the invention comprises a top wall with one or several recess(es), the recess(es) being inwardly located into a border area of the top wall. According to an embodiment, the invention aims a tool to seal a bottle neck by a stopper, the stopper comprising a top protruding part relative to a top surface, the tool comprising
a body with an inner hollow housing,
the housing is complementary shaped relative to the stopper to engage the stopper therein
the housing comprises a top wall and a peripheral wall, the top wall comprising at least one contact surface with the top surface of the stopper
   wherein
the top wall comprises one or several recess(es),
the recess(es) is located into a border area of the top wall.

According to another embodiment, the recess(es) is shaped to receive at least the protruding part of the stopper.

According to another embodiment, the tool further comprises
one recess, the recess has a circular shape.

According to another embodiment, the tool further comprises
a pusher and a hole,
the hole being located in a middle area of the body,
the pusher is vertically slidable into the hole,
the at least one contact surface is located between the hole and the recess(es).

According to another embodiment, the pusher comprises a bottom end,
the at least one contact surface comprises the bottom end.

According to another embodiment, the tool further comprises
several contact surfaces, the contact surfaces are regularly distributed around the top wall.

According to another embodiment, the tool further comprises
three contact surfaces.

### BRIEF DESCRIPTION OF THE DRAWINGS

The invention can be better understood on reading the following description given merely by way of example and with reference to the accompanying drawings, in which:

FIG. 1 is a diagrammatic section view of a tool according to a first embodiment;

FIG. 2 is a diagrammatic section view of FIG. 1, wherein a stopper is engaged into the housing of the tool;

FIG. 3 is a diagrammatic section view similar to FIG. 2, wherein the stopper comprises a top protruding part, especially showing a pusher into its top position; and

FIG. 4 is a diagrammatic section view similar to FIG. 3, especially showing the pusher into a position wherein the bottom end of the stopper is in contact with the top wall of the stopper.

### DESCRIPTION OF EMBODIMENTS

As required, detailed embodiments of the present disclosure are disclosed herein. The disclosed embodiments are merely examples that may be embodied in various and alternative forms, and combinations thereof. As used herein, for example, exemplary, and similar terms, refer expansively to embodiments that serve as an illustration, specimen, model or pattern.

In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

Phrasing such as ‘configured to’ perform a function, including in the claims, can include any or all of being sized, shaped, positioned in the arrangement, and comprising material to perform the function.

Terms indicating quantity, such as ‘first’ or ‘second’ are used for exemplary and explanation purposes and are not intended to dictate the specific ordering of a component with respect to other components. Terms indicating position such as ‘upper’ and ‘lower’ or ‘front’ and ‘back’ are used to indicate components relation to one another. One of skill in the art would recognize other configurations are possible.

Various embodiments of the present disclosure are disclosed herein. The described embodiments are merely exemplary illustrations of implementations set for a clear understanding of the principles of the disclosure. Variations, modifications, and combinations may be made to the described embodiments without departing from the scope of the claims. All such variations, modifications, and combinations are included herein by the scope of this disclosure and the claims.

The invention relates to a tool 1, also called “capping chuck”.

Such tool 1 is used to seal a neck of a container, such as a bottle, by a stopper 2.

As aforementioned, a stopper 2 globally has a tubular or cylindrical shaped body closed at its top edge by a roof wall. The stopper body comprises a closure shell bottomly attached to a tamper band (also called “tamper evident band”) through a weakness line. Such weakness line is made of bridges, distributed around the closure shell and the tamper band. So the bridges link the closure shell and the tamper band together. The bridges are made when molding the stopper or after molding through a cutting step.

The tool 1 is especially used to seal a bottle neck by a stopper 2. The stopper 2 can be of a screw type or a snap type, or even of a combination of screw type and snap type. According to a screw type stopper 2, the closure shell comprises inner thread(s) arranged on the inner side walls. In order to engage the stopper 2 to seal the bottle neck, the peripheral wall of the neck comprises outer complementary fixation features, such as outer thread(s). The combination of outer and inner thread(s) allows the stopper 2 to be screwed on the bottle neck to seal said container and unscrewed for container opening. Moreover the tamper band comprises an inner annular bead, located at a bottom part. Such inner bead cooperates with an outer annular ring outwardly managed on the peripheral wall of the bottle neck, under the outer thread(s).

When sealing the bottle by screwing the stopper 2 on the bottle neck, the bead crosses the outer ring and gets engaged in order to lock the tamper band relative to the bottle neck. So, when opening by unscrewing the stopper 2, the tamper band remains on the bottle neck and only the closure shell is moved up. During unscrewing, the bridges of the weakness line are torn apart from the closure shell until they break and the closure shell can be moved relative to the tamper band secured on the bottle neck.

Thenceforth the tool 1 is used to engage the stopper 2 and apply it on the bottle neck, by screwing or snapping, until the stopper 2 is secured.

Therefore the tool 1 comprises a body 4. The body 4 can be made of one or several pieces.

According to an embodiment, when the stopper 2 comprises top parts laterally protruding relative to bottom parts, the body 4 of the tool 1 comprises several parts, such as jaws. The jaws are laterally movable relative to the body 4, in order to allow the insertion and the further ejection of the stopper 2. In other words, when the stopper 2 comprises a top diameter greater than a bottom diameter, then the body 4 comprises jaws that are allowed to be moved into a opened position when inserting the stopper and into a closed locking position once the stopper 2 is fully inserted and to secure the stopper 2 into the housing 6. Such jaws can also be called “sliders” or “split halves”, alike in a mold.

The body 4 comprises an inner hollow housing 6, in order to inwardly receive the stopper 2. So the housing 6 is made into the body 4. The housing 6 is complementary shaped relative to the stopper 2 to engage the stopper 2 therein. In other words, the housing 6 comprises almost the same inner dimensions as the outer dimensions of the stopper 2, such as the same or diameter. Especially, the height of the housing 6 is corresponding at least to the height of the top part of the stopper 2 to be inserted therein, so that the tamper evident band of the stopper 2 can be located outside the housing 6 allowing the tamper evident band to radially expand upon insertion onto the bottle neck. As the stopper 2 globally is cylindrically shaped, the housing 6 is also globally cylindrical. The stopper 2 can also have globally other shapes, such resulting as comprising an “overcap” inserted around the stopper 2, so the housing 6 is complementary shaped in order to receive such shaped “overcap”.

Thus the housing 6 comprises a top wall 8 and a peripheral wall 10, which delimit the inner of a space which is intended to receive the stopper 2. The top wall 8 is located at a top edge of the peripheral wall 10.

Moreover the top wall 8 comprises at least one contact surface 80 with a top surface of the stopper 2. In other words, a top plane part of the stopper 2, such as the roof, comes into contact with each contact surface 80 of the top wall 8, which allow the stopper 2 to be correctly oriented into the housing 6, especially in a horizontal way which is parallel to the top wall 8.

According to an embodiment, the peripheral wall 10 comprises teeth. The teeth are regularly distributed around the peripheral wall 10, or not. The teeth are complementary shaped relative to the knurls made on an outer peripheral wall of the stopper 2. The cooperation of the knurls with the teeth when the tool 1 is engaged on the stopper 2, angularly secure the stopper 2 into the housing. Thereby once inserted, the stopper 2 cannot turn relative to the tool 1.

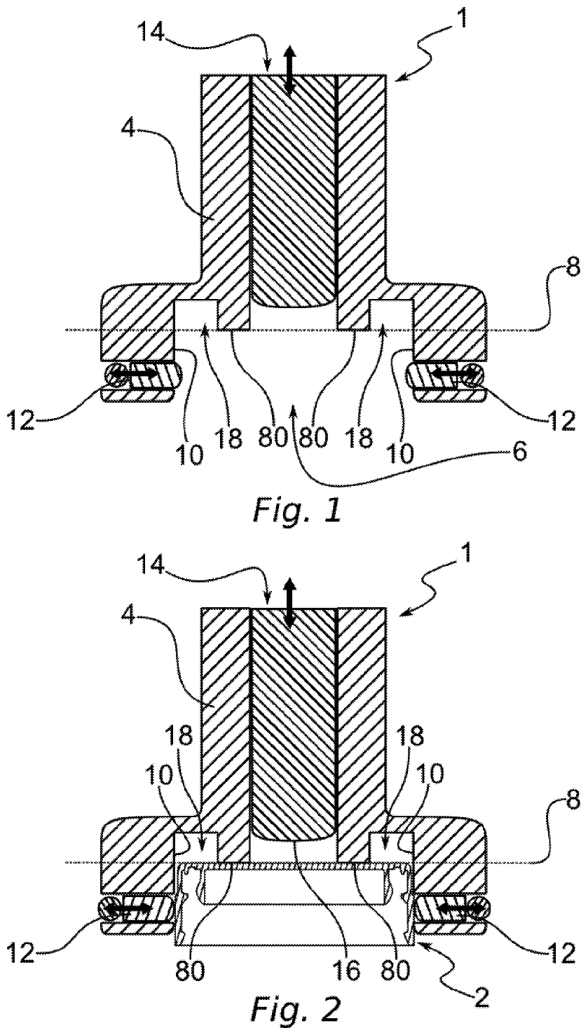

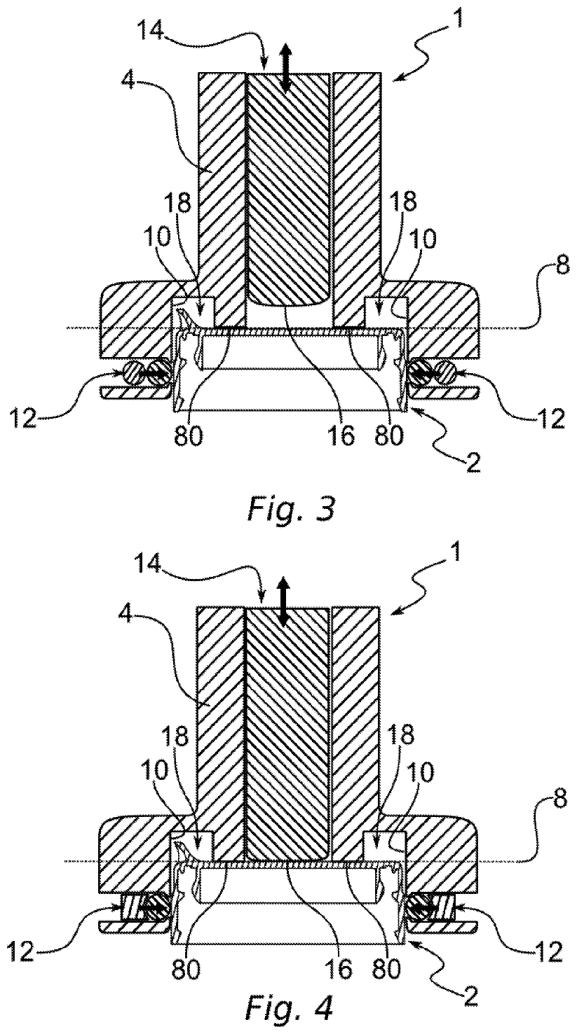

According to an embodiment, the inner peripheral wall 10 of the housing 6 comprises secure features, such as detents 12. Several detents 12 are distributed around the inner peripheral wall 10, regularly or not. The number of detents 12 can be even or odd. Especially, when there is an even number of detents 12, two of the detents 12 are diametrically located relative to each other, in order to pinch the stopper 2 and hold said stopper 2 once engaged into the housing 6. The detents 12 are located around the inner peripheral wall 10 at the area of the teeth. The detents 12 are movable in an horizontal direction relative to the tool 1, along a hollow channel complementary made into the body 4. The detents 12 can be repelled into a pinch position thanks to elastic features, such as springs or thanks to elastomeric components, such as an o-ring or a quad-ring. The inner extremity of each of the detents 12 usually comprises a spherical ball such as shown in FIGS. 3 and 4, or a cylindrical element such as shown in FIGS. 1 and 2, to get into contact with the knurls of the stopper 1. So when the stopper 2 is engaged into the tool 1, the detents 12 are pushed into their channels and the repelled forces of the detents 12 secure the stopper into the housing 6.

According to an embodiment, the tool 1 comprises a pusher 14 in order to eject the engaged stopper 2. The pusher 14 is top and middle located into a hole centrally made into the housing 6. The pusher 14 is vertically slidable a relative to the hole from a top to a bottom position, and reversely. So once the stopper 2 is sealed on the bottle neck, the pusher 14 is downwardly moved from the top position to the bottom position in order to push on a top surface of the stopper 2, to eject the stopper 2 from the housing 6.

Moreover the pusher 14 comprises a bottom end 16. The bottom end 16 enters in contact with the top surface of the stopper 2, in order to eject it from the housing 6. Such ejection is realized when the pusher 14 is activated. Reversely, when not activated, the pusher 14 is repelled into the hole and the bottom end 16 is located along or over the top wall 8. In other words, the bottom end 16 is flushed with or spaced from the top wall 8, when the pusher 14 is inactive.

Henceforth, when sealing a bottle neck, the stopper 2 is engaged into the housing 6 of the tool 1. The tool 1 is positioned over the bottle neck and the tool 1 is moved in rotation, so that the inner thread(s) of the stopper 2 cooperate with the outer thread(s) of the bottle neck until the bead of the tamper band crosses the outer ring of the bottle neck to lock the stopper 2 relative to the bottle neck.

According to the invention, the tool 1 is designed to receive a stopper 2 comprising a top protruding part relative to the top surface of the stopper 2. Such protruding part can be a tongue, which is useful for the consumer to open the closure shell of the stopper 2 when drinking Especially the consumer opens the bottle by pushing with a finger against the tongue of the closure shell from approximately in a direction bottom to top.

Thus, according to the invention, the top wall 8 comprises one or several recess(es) 18. The recess(es) allows the protruding part of the stopper 2 to enter therein, so the stopper 2 remains perfectly oriented into the housing 6.

According to an embodiment, such as shown in FIG. 3, the recess(es) 18 is shaped to receive at least the protruding part of the stopper 2.

Alternately, the tool 1 comprising a recess(es) 18 also allows a stopper 2 with a plane top surface, to be inserted into the housing 6. Such possibility is visible in FIG. 2, showing a stopper 2 with a flat top surface inserted into the housing 6 of the tool 1.

As the protruding part is located around the top surface of the stopper 2, the recess(es) 18 is located into a border area of the top wall 8. In other words, the recess(es) 18 are not centered, but distributed around the top wall 8 of the housing 6.

According to an embodiment, as previously mentioned, such as shown in the figures, the tool 1 comprises a pusher 14 which is vertically slidable into the hole. Moreover the hole is located in a middle area of the body 4. Thenceforth the at least one contact surface 80 is located between the hole and the recess(es) 18.

According to an embodiment, such as shown in FIG. 4, the at least one contact surface 80 comprises the bottom end 16 of the pusher 14. In other words, when the pusher 14 is repelled, the bottom end 16 is part of the contact surface 80. So the bottom end 16 is aligned with the top wall 8 and the contact surface 80.

According to a preferred embodiment, the tool 1 comprises only one recess 18. Then the one recess 18 has a circular shape, so the protruding part of the stopper 2 can insert into the recess 18, whichever angular position of the stopper 2 relative to the housing 6. In other words, the recess 18 angularly extends along all the periphery of the housing 6, alike a hollowed ring.

According to an embodiment, the tool 1 comprises one contact surface 80. So the contact surface 80 extends angularly extends along all the periphery of the housing 6, alike a ring.

According to an embodiment, the tool 1 comprises several contact surfaces 80. The contact surfaces 80 are regularly distributed around the top wall 8. So the contact surfaces 80 are spaced from each other, in an interrupted or discontinuous way. In other words, the recess(es) 18 separates the contact surfaces 80 from each other. Then the recess(es) 18 is radially linked to the hole of the pusher 14.

According to an improvement of an embodiment, the tool 1 comprises three contact surfaces 80. As far as the contact surfaces 80 are regularly distributed, they create an isostatic support system of the stopper 2 into the housing 6.

1. A tool to seal a bottle neck by a stopper, comprising:
a body with an inner hollow housing,
wherein the stopper comprises a top protruding part relative to a top surface,
wherein the housing is complementarily shaped relative to the stopper to engage the stopper therein,
wherein the housing comprises a top wall and a peripheral wall, the top wall comprising at least one contact surface with the top surface of the stopper,
wherein the top wall comprises one or several recess(es), and
wherein the recess(es) is located in a border area of the top wall.

2. The tool according to claim 1, wherein the recess(es) is shaped to receive at least the protruding part of the stopper.

3. The tool according to claim 1, comprising one recess, wherein the recess has a circular shape.

4. The tool according to claim 1, further comprising:
a pusher and a hole, wherein
the hole is located in a middle area of the body,
wherein the pusher is vertically slidable into the hole, and
wherein the at least one contact surface is located between the hole and the recess(es).

5. The tool according to claim 4, wherein the pusher comprises a bottom end and the at least one contact surface comprises the bottom end.

6. The tool according to claim 1, further comprising several contact surfaces, wherein the contact surfaces are regularly distributed around the top wall.

7. The tool according to claim 1, further comprising three contact surfaces.
